(19) United States
(12) Patent Application Publication
(10) Pub. No.: US 2019/0012754 A1
(43) Pub. Date: Jan. 10, 2019

(54) Social Learning Platform

(71) Applicant: LIFE IS DIGITAL, LLC, Southfield, MI (US)

(72) Inventors: Matthew Eleweke, Southfield, MI (US); Mark Meyers, Toledo, OH (US)

(73) Assignee: LIFE IS DIGITAL, LLC, Southfield, MI (US)

(21) Appl. No.: 16/031,900

(22) Filed: Jul. 10, 2018

Related U.S. Application Data
(60) Provisional application No. 62/530,656, filed on Jul. 10, 2017.

(51) Int. Cl. G06Q 50/20; G09B 5/14; G09B 5/12; H04L 12/58

(52) U.S. Cl. CPC G06Q 50/205; H04L 51/046; G09B 5/125; G09B 5/14

(57) ABSTRACT

A system for peer to peer collaboration and learning through a mobile application is provided. The system includes a remote network hosting a database of institution specific information including a list of available classes. A mobile application is operable to connect remotely to the remote network. A profile feature is provided in the mobile application and is customizable to a user of the application to allow the user to input information. The mobile application includes a menu feature allowing access to the list of available classes and allows the user to select a class from a list of classes. A classmate feature is provided in the application to provide a list of classmates enrolled in a corresponding class. A study group feature is provided to allow the user to generate a study group having one or more parameters. The mobile application further includes a map feature.

### CROSS REFERENCE TO RELATED APPLICATION

Priority is claimed to U.S. Provisional Application No. 62/530,656 filed Jul. 10, 2017 which is incorporated herein by reference in its entirety.

### FIELD

The present disclosure relates generally to social learning platform systems and methods for peer-to-peer communication and collaboration. Particularly, systems and methods of connecting users to related classroom activities, study groups and the like. More particularly, the present disclosure relates to an application for students of universities/colleges and the like to stay connected and engaged with their classmates and professors while outside of the classroom through a mobile platform.

### BACKGROUND

The statements in this section merely provide background information related to the present disclosure and may not constitute prior art.

Universities deal with year-to-year increases in dropout rates due to lack of academic retention. This is due in part to the difficult experience students have in determining who is in their classes, as well as finding a means of which to communicate with such classmates.

Learning Management Systems (LMS) and other platforms have shown success when implemented in higher education institutions. Platforms such as D2L and BLACKBOARD® have existed for many years, yet continue to have problems as evidenced by issues raised from users and faculty. Students and faculty regularly complain about these systems, but are compelled to use them because the existing LMS take a one-sided approach of improving the faculty experience while ignoring the students.

A need exists for a functional and effective platform and system for improved peer-to-peer communication and engagement for educational institution environments.

### SUMMARY

The present disclosure provides for an application system and method operable for enhancing peer-to-peer engagement. The application and platform allows for students to build a learning network with others, giving them a greater chance to reach their academic potential. In an example, this can be accomplished by creating a social learning platform focused on connecting students with one another, providing them the capability to create study groups, communicate with classmates and faculty, manage their schedules, be sent notifications regarding syllabus due dates, and be given predictive individualized recommendations for academic success. In another example, the system and method includes a live group study feature that gives students the ability to easily find classmates on campus, while outside of the classroom, who are studying in real time.

According to the present disclosure, an example peer-to-peer engagement application system directed to students of a college, university or the like can include a plurality of resources within the application such as an interactive calendar, a group study feature, as well as a live study map to promote improved quality education. By effectively assisting in connecting students to each other aligned with their respective academic courses, students are able to feel engaged and their demand for secondary resources can be reduced or even eliminated.

Cooperative learning is known to significantly improve education. An application according to the present disclosure can help students build interpersonal relationships among classmates while improving their grades. Students using the system and method disclosed herein may perceive learning in a different way as compared to existing traditional classroom settings. The system and method provide for a platform that directly links education and socializing, which does not currently exist. Moreover, students will be provided with increased autonomy as compared to other learning management systems.

The present disclosure provides for a system for peer to peer collaboration and learning through a mobile application. The system includes (a) a remote network hosting a database of institution specific information including a list of available classes associated with the institution; (b) a mobile application provided on a mobile device operable to connect remotely to the remote network; (c) a profile feature provided in the mobile application, the profile feature being customizable to a user of the application allowing the user to input information including information associated with the institution; (d) a menu feature allowing access to the list of available classes associated with the institution, the menu feature provided in the mobile application allowing the user to select a class from the institution the user is enrolled; (e) a classmate feature provided in the application operable to provide a list of classmates enrolled in a corresponding class, the classmate feature operable to allow communication between the user and at least one classmate through the application; (f) a study group feature provided in the application to allow the user to generate a study group having one or more parameters selected from the group consisting of a privacy setting, number limit, location, time, subject, content, and combinations thereof; and (g) a map feature provided in the application, the map feature operable to submit a notification to the user of at least one study group available to the user. The notification includes at least one parameter of the study group. The study group feature allows the user to submit a request to join and further allows a member from the study group to submit a response to allow or deny the request. In an example, the parameter provided in the map feature is a location parameter associated with a map of the institution.

In an example, the system further includes a grading feature that allows for classmates to submit a grade of other classmates associated with study habits. The grade for the user is shown on the profile feature.

In yet another example, the system includes a calendar feature provided in the application. The calendar feature is operable to provide class specific information associated with the enrolled class. The class specific information is located in the database of institution specific information hosted on the remote network. The class specific information includes at least one member selected from the group consisting of syllabi content, deadlines, content provided from an instructor, and combinations thereof. The mobile application can further include a messaging feature operable to allow for communication between the user and at least one other user through direct messaging.

In yet another example, the system further includes a news feed feature in the application that compiles at least some data and information related to the user and displays that compiled information in chronological order for a given time period. The user behavior and study group formation can be tracked and collected as data. The collected data can then be processed and provided as feedback to the institution. The collected data can also trigger notifications to be sent to the user corresponding to recommendations based on the processed data.

The present disclosure provides for a method for peer to peer collaboration using a mobile application. The method includes: (a) hosting a database of institution specific information including a list of available classes associated with an institution on a remote network; (b) providing a mobile application on a mobile device operable to connect remotely to the remote network; (c) generating a user specific profile through a profile feature provided in the mobile application, wherein the profile feature is customizable to a user of the application allowing the user to input bibliographical information including information associated with the institution; (d) selecting at least one class associated with a class the user is enrolled from a menu feature provided in the mobile application, the class being selected from a list of classes provided from the database of institution specific information hosted on the remote network; (e) connecting with at least one classmate through a classmate feature provided in the mobile application, the classmate feature providing a list of classmates also enrolled in a selected class to the user, the classmate feature operable to allow communication between the user and at least one classmate; (f) generating a study group having at least two classmates from an enrolled class through a study group feature provided in the mobile application, the study group feature having one or more parameters selected from the group consisting of a privacy setting, number limit, location, time, subject, content, and combinations thereof; (g) notifying, through a notification feature of the mobile application, at least one user not part of the generated study group of the formation of the study group and its availability to the user through a map feature provided in the application, wherein the notification includes at least one parameter of the study group; and (h) submitting a request to join the study group through the study group feature and allowing a member from the study group to submit a response to allow or deny the request.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings in which:

FIG. 1 is a flow diagram illustrating an example system according to the present disclosure.

FIG. 2 is a diagram illustrating an example method according to the present disclosure.

FIG. 3 is an exemplary registration feature and screenshot according to the present disclosure.

FIG. 4 is an exemplary profile feature and screenshot according to the present disclosure.

FIG. 5 is an exemplary university class list feature and screenshot according to the present disclosure.

FIG. 6A is an exemplary class home screen according to the present disclosure.

FIG. 6B is an exemplary classmate listing for an example class and screenshot according to the present disclosure.

FIG. 7 is an exemplary study group feature for creating a study or meeting group according to the present disclosure.

FIG. 8 is an exemplary map feature associated with finding a study session according to the present disclosure.

FIG. 9 is an exemplary messaging feature according to the present disclosure.

FIG. 10 is an exemplary calendar feature according to the present disclosure.

FIG. 11 is an exemplary personalized news feed feature.

FIG. 12 is an exemplary screen shot for a specific class and the corresponding information for that class including upcoming assignments and lectures.

FIG. 13 is an exemplary flow diagram illustrating a further method of providing data feedback and notification to users according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

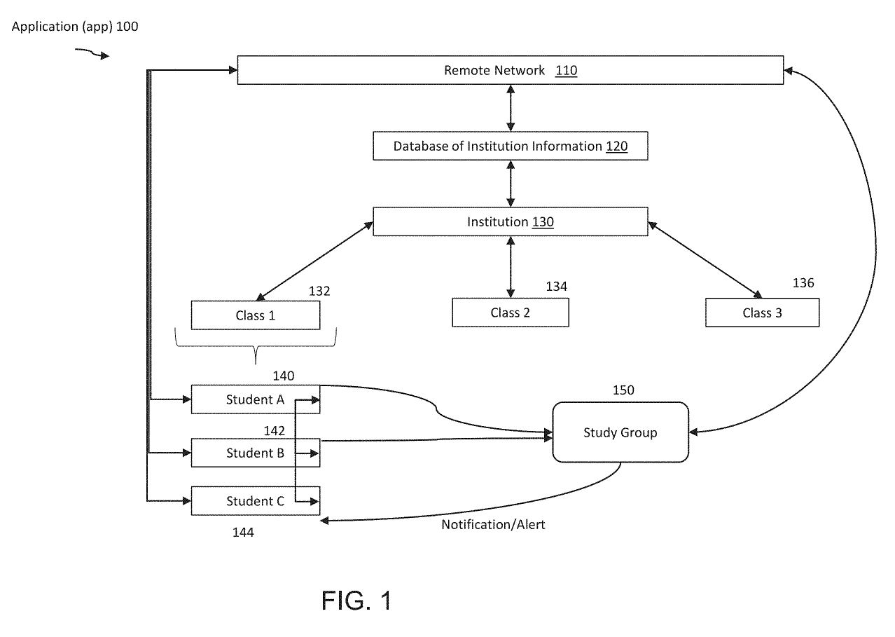

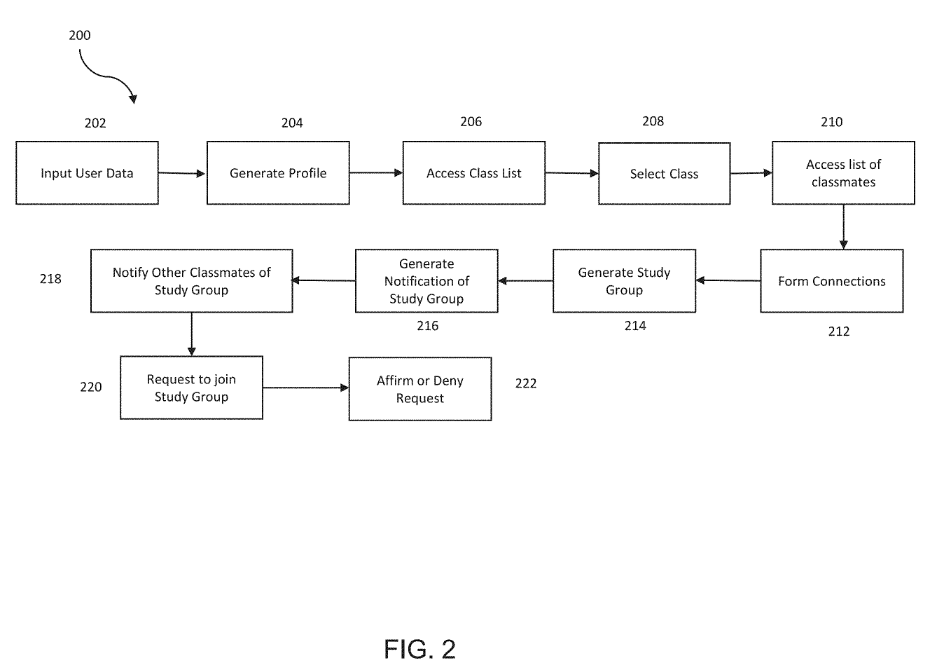

Referring to FIGS. 1-2, example process flow diagrams are shown to illustrate the system and method of the present disclosure. In one form, the present disclosure provides for a system 100. System 100 includes a mobile application (app) that accesses a remote network 110 operable to be accessed by a user through the app which is provided on a mobile device or through a software hosted on a computing device. Example mobile devices include smart phones and tablets operable to communicate with the remote network 110 through an internet connection. The mobile app is downloadable through any known app store such as APPLE or GOOGLE.

Remote network 110 can be hosted on a cloud-based platform or through a server network.

The remote network 110 is operable to host a database of institution information 120 that is obtained from each institution 130. Institution 130 can be any institution of higher learning, for example, a college or university. In another example, the institution 130 is any educational institution including classes K-12 for both public and private schools. In yet another example, the institution 130 is a business. Each institution 130 includes a plurality of classes such as class 1, 2 and 3 shown in boxes 132, 134, and 136. As discussed later, the list of classes for an institution 130 can be categorized by major and accessed by a user through the remote network 110. Each class can include a plurality of information such as relevant due dates, upcoming lectures, syllabi information, time, location and a corresponding list of enrolled students or users.

In this example, class 1 shown in box 132 includes three students, student A shown in box 140, student B, shown in box 142, and student C, shown in box 144. Student A can access the remote network 110 through an application (app.) provided on a mobile device. Student A can generate a profile and associate themselves with institution 130 and then enroll for access to the information from Class 1. This includes a class list that will show them classmates student B and student C. The system 100 can be configured to only show classmates who have registered and are also using the app. These students can connect through the application and communicate using a communication tool and features of the app.

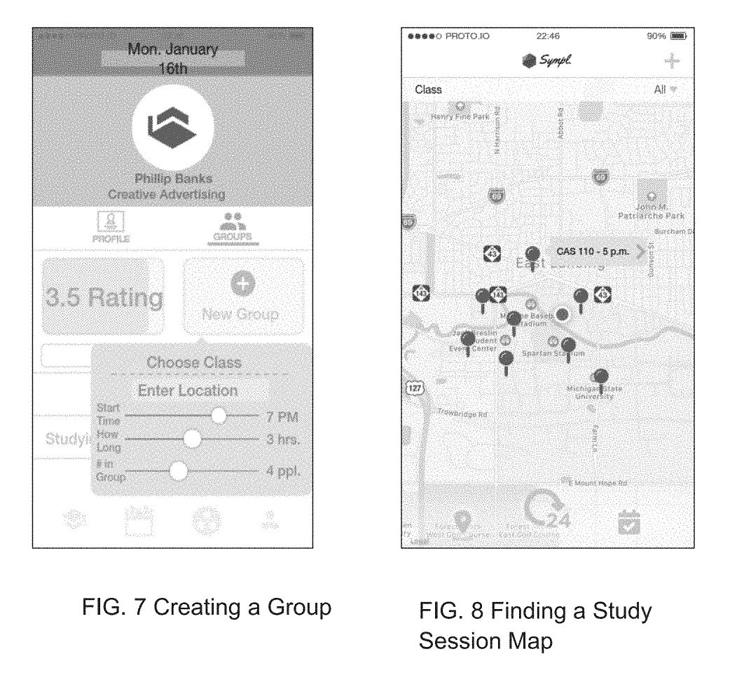

The app further allows for the formation of study groups 150. In this example, student A and student B are able to form the study group 150. In an example, student A and student B agree on a time and location, such as a study lounge, dorm room or common area, a coffee shop, and the like. At least one of the students A or B then generates a “study group” notification through the app. The subject matter, time, and location are at least some of the information that is included in the study group notification (as shown in FIG. 7). The formation of the group can then send out a notification to student C and other students that a study group 150 and study session has been formed. This information can be accessed through a map feature of the application. Student C is able to receive the notification through connecting to the remote network 110 via a mobile device. The notification feature can be set through the app as automated or turned off.

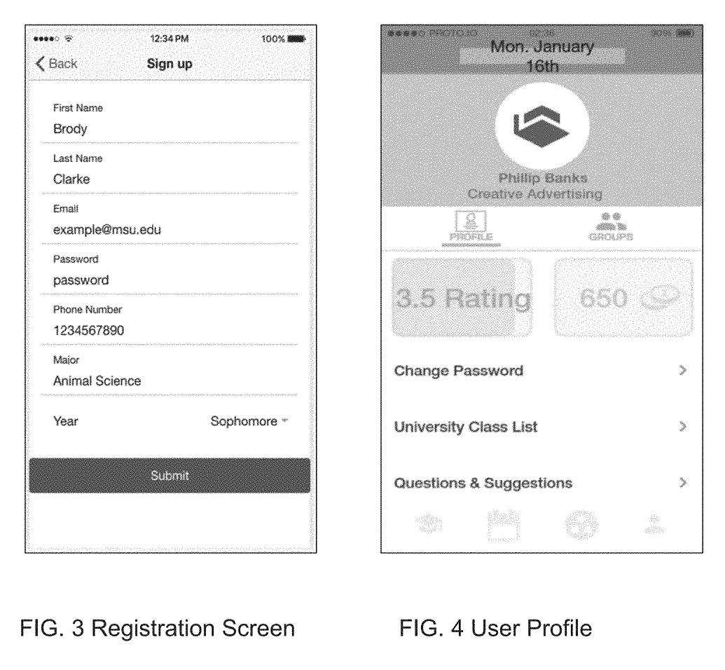

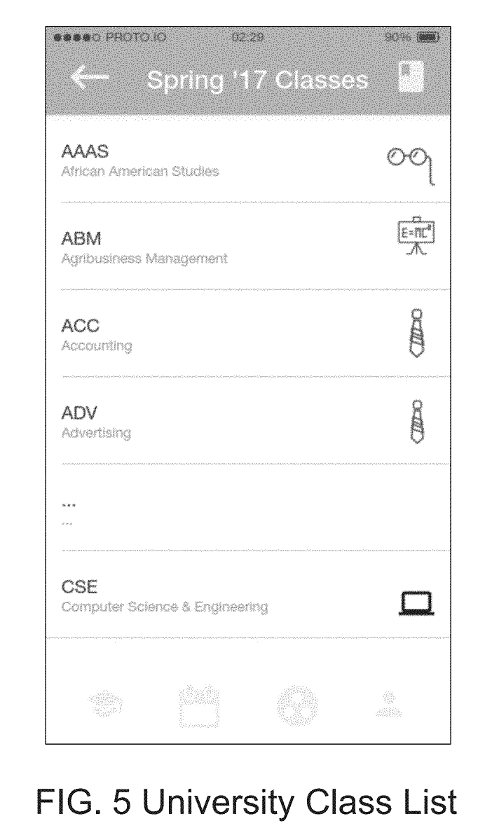

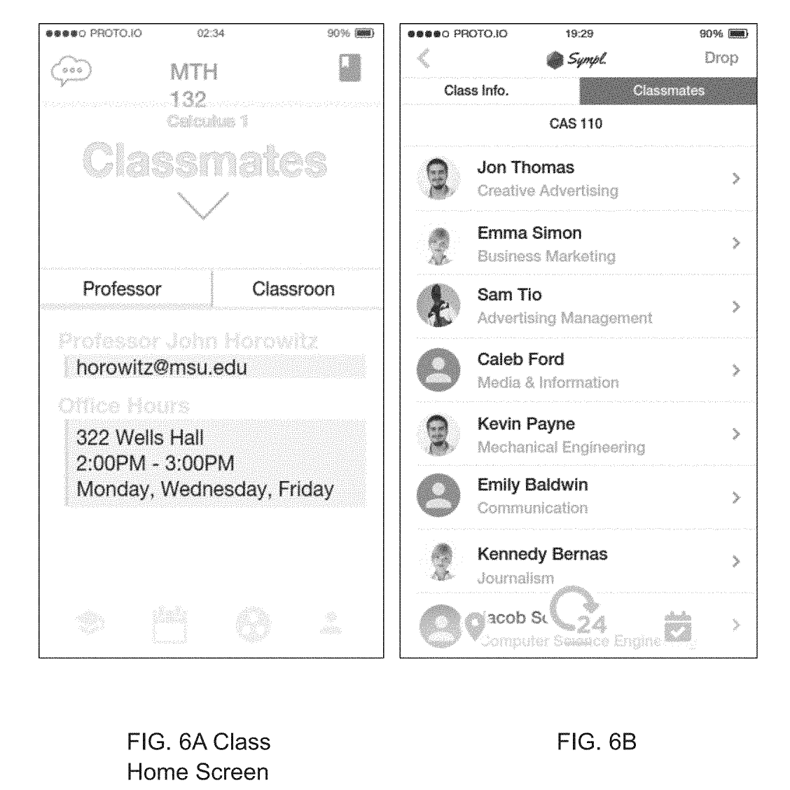

Referring to FIG. 2, a method 200 is shown according to the present disclosure. Method 200 relates to the use of a downloadable app (as discussed above relative to system 100). The app is provided on a mobile device that allows for accessing personalized class information and collaborating with classmates using the mobile device. The user first downloads the mobile app and then begins use through method 200. In this example, method 200 proceeds from box 202 where a user, such as student A, B, or C, inputs individual specific data into the app as shown at box 202. Inputting the data through a registration feature and screen as shown in FIG. 3 generates a profile shown at box 204. The user is then able to access a class list, shown in FIG. 5, as shown in box 206 and select a class from which the user is enrolled in box 208. By selecting a class in box 208, the user receives access to fellow classmates (FIG. 6B) who are also enrolled in the class as shown in box 210. The user can then form a connection with one or more classmates in box 212 through a connection request feature. This creates a peer-to-peer connectivity within the app and allows for communication and collaboration among the students in the class.

The method continues by forming study groups through the app. A study group can be generated by one or more users as shown in box 214. The study group can include one or more parameters such as time, location, availability, subject matter, among others. Those parameters can be shared through a notification that is generated in box 216. The notification is then sent to one or more other classmates as shown in box 218 providing the relevant information. Those fellow classmates receiving a notification are able to see who else in the class is studying, what they are studying, how many are participating, and then, if desired, submit a request to the participants of the study group 214 to join the study group as shown in box 220. The members of the study group 214 are then able to either affirm or deny the request. Accordingly, this allows for increased and improved collaboration and interaction among the students of a class.

The system 100 and method 200 can further correspond to a business or enterprise application customized to a particular organization. In an enterprise example, the app would allow for users assigned to a specific project to interact, view deadlines, communicate and generate meetings in the same fashion as the examples of the educational application discussed above.

The present disclosure further provides for a social learning platform through the use of a mobile education technology app that allows for user input of personal data related to the user's specific educational class load, collecting the input together with a corresponding institution, its class listings and corresponding syllabi, connecting the user with at least one other classmate, an instructor, a teaching assistant and/or others connected to a specific class and providing a platform for those users to interact, communicate, share information and generate locatable study groups. Moreover, data tracking of student and user activity can be achieved which provides feedback to the institutions and instructors. The system can also learn from patterns generated through the data and make effective determinations. For example, if the app notices that a student is attending several study sessions or frequently communicating about a specific topic, the system can send them a refresher module or a notification to perhaps review certain background material. Moreover, the instructors can be notified that a certain subject matter is causing an uptick in study group formation and collective discussion and thus, perhaps the material is more difficult than normal. The instructor can then respond accordingly to this influx of data and increased information.

The mobile app and system of the present disclosure gives students the ability to sign up for classes, collaborate with peers, be connected to professors, discover and start study groups, have an automatically populated course calendar to give them daily reminders, as well as receive feedback based on behavior, for example the user may receive a grade and be given insights on their individualized study habits using predictive machine learning. Moreover, the present disclosure further provides for a system that allows study groups to be formed by one or more users, providing a location on a map accessible by other students and allowing students to request permission to join the study group as well as authorization access by the study group creators to such a request. Still further, the application may allow for the study groups to be formed virtually through a live video feature.

Referring to FIGS. 3-12, example illustrations and screen shots are shown of the mobile app showing features of the social learning platform system and method of the present disclosure. The app allows for the performance of the system and method disclosed herein. A user can download or acquire the app using any mobile device such as a smart phone and/or a tablet. Upon initiating the app, a user will be sent to a login screen. If a user is not currently registered in the application, they can be navigated to a registration screen. An example registration screen is shown in FIG. 3 to sign up for the application which includes the user's specific information including first and last name, email address, password, phone number, major, and class year. A user may be asked to provide an email address having a “.edu” extension which was supplied by universities upon enrollment. This can be used as a key to access that institution's specific class list and information. The application can be designed to be restrictive to non-affiliated users in order to avoid unwanted participants in the community such as spam, hackers, and destructive users. For example, the application can be set up so students without the “.edu” extension for that institution are not able to register.

In this example, the app, through the registration feature, asks users to provide identifying and bibliographic information such as their first and last names, major, and their class status. Optionally, users may provide additional information such as their phone number for back up identification purposes. Once a user has entered information, an account can be created specific to that user. In one form, a verification step can be added such as supplying a clickable verification email to confirm the account. In yet another example, the student ID or other information is verified by the institution before allowing access to the institution's specific information.

In yet another example, a question and suggestions feature is accessible through the app. This allows the system to facilitate communication between the institution and its users. Additionally, a settings page can be added so that students can be in control of what information can be accessed to help mitigate privacy concerns.

The social learning platform of the present disclosure further includes an accessible database having a list of classes (FIG. 5) for a particular semester or term associated with a particular institution. The class list for a particular semester or term can be provide by the institution and imported through a variety of techniques into a remote database hosted on a server for the remote network. In an example, the class list can be imported through a technique such as web and EXCEL® scraping tools developed and customized to the system disclosed herein, or through a institution supplied API to access the data. The class list is then accessed through the application on a user's mobile device. Once the class list is imported, an uploading script is used to format the list, and push the list from a data structure stored on the network computer to an access database to which the application itself sends requests. Each class list uploaded to the database may include a field that specifies the institution (such as the college or university) that the classes are associated with. For a non-education based application such as a business or the like, projects and departments can replace class lists and users can replace students.

A student is then able to access the accessible class list from the user's profile feature, as can be seen in FIG. 4. Once selecting an institution, the application will send a request to the remote network server to retrieve all of the university classes that the current user is associated with. The application will then narrow the results into the corresponding prefix, i.e. CSE for Computer Science and Engineering or BLS for Biomedical Laboratory Sciences. A sample class list feature is shown in FIG. 5.

A next step includes selecting a class prefix, where a user will be able to navigate through the different classes, select a class and a section, be sent to an enrollment screen with all available class information, and then choose to confirm that they are enrolled in that class at their institution. A confirmation step can be provided. Once confirmed, the user will have access to all of the available features for that specified class. A user is able to withdraw from a class on the app at any time once enrolled through the app. In yet another example, the user can set to receive or not receive notifications associated with that particular class.

In an example, once a user is enrolled in at least one class, they are able to view at least one of the other users in that class through a home screen linked to that class. An example of the class home screen can be found in FIG. 6A. In even yet another example, the list of classmates, shown in FIG. 6B, are sorted for a particular class listing. First classmates who have been prior connections to the user based on frequency of interactions can be shown first. In this example, the users major is also shown. The app allows for the user to toggle between class info and classmate list. In this example, that feature is shown towards the top of the screen. Additionally, the class page may be populated with certain class information such as professor, location, and time. This gives students the ability to see who is in their classes, and gives them the ability to make meaningful connections through education. These connections lead to an increase in academic performance by the user and allows the users to have direct and easy access to information.

As shown in FIGS. 7 and 8, the present disclosure further provides for a group study feature accessible through the app. Allowing the user to have access to classmates facilitates collaborative learning through the group study feature. In one form, the group study feature allows users to create a group for a particular class and invite classmates to join the group. In one example, the group can be provided with privacy settings for being invite only or alternatively open to the public. Once the study group is created, the user is able to create a study session by specifying one or more parameters such as: location, start time, duration, content, and privacy of the group.

The study session may either be private, where only members of the group are able to see it, or public, where anyone in the class is able to see it. Additionally, a user can select a rating parameter such as a “minimum rating so as to only invite classmates that study well together. An example of creating a group session is shown in FIG. 7. In yet another example, some or all classmates and instructors are automatically added to a class group, so that constant communication between classmates and professors can be facilitated through the app. This allows students to create an ad hoc study session without having to create an additional study group.

The present disclosure further provides for an alert that is generated and sent to members of a group or connected classmates upon the formation of a study group or other parameters such as location proximity or time of study. For example, if student A is in one dorm where a study group for his or her class has been formed or about to start, student A receives an alert through the application to notify him or her of the event. This alert can trigger student A to request participation in the group. Through the app, student A can submit a request which is then communicated to the existing study group. The study group can then approve or deny the request. Moreover, the application has the added benefit of simply notifying classmates and reminding them not only to start studying but also that their peers are currently studying thereby encouraging studious behavior.

The present disclosure provides for allowing a user to search for existing groups. For example, assume a group's study session is declared public. A notification is then sent from the remote network to users of the application who are in the class and the creation of the group will be shared with the rest of the class. If a user were to look for a study group through the application, while the public study session was active, the user would be able to go to a “Find a Study Group” screen. This screen of the application may include a map of the institution's campus or nearby locations (as shown in FIG. 8), and a list of all study sessions for the courses for which they are enrolled. All active study groups that the user can be a part of will be found as markers on the map. When selecting a marker a user would be able to see some or all of the group's information including but not limited to the duration of the study period, the exact location of the study group, the group or student which initiated the study session, and/or all members currently studying at that location.

In another example, if the user's GPS location is within a specified radius of the group's location, which can be calculated using a distance formula derived from the Pythagorean Theorem, the user is able to request to join the study session. At least one or more members of the group, such as the creator of the study session, is able to approve or deny requests. In yet another example, when the user is no longer within the radius of the study session, they will automatically be removed. A user can leave a study session at any time. Once a parameter has been satisfied, for example no user associated with the session is within the radius of the study location, the duration has elapsed, an/or the session leader ended the session, the session will close and no longer be detectable on the “Find a Study Group” screen. The duration that individual users are a part of a study session can be logged in a database so further analysis can be completed.

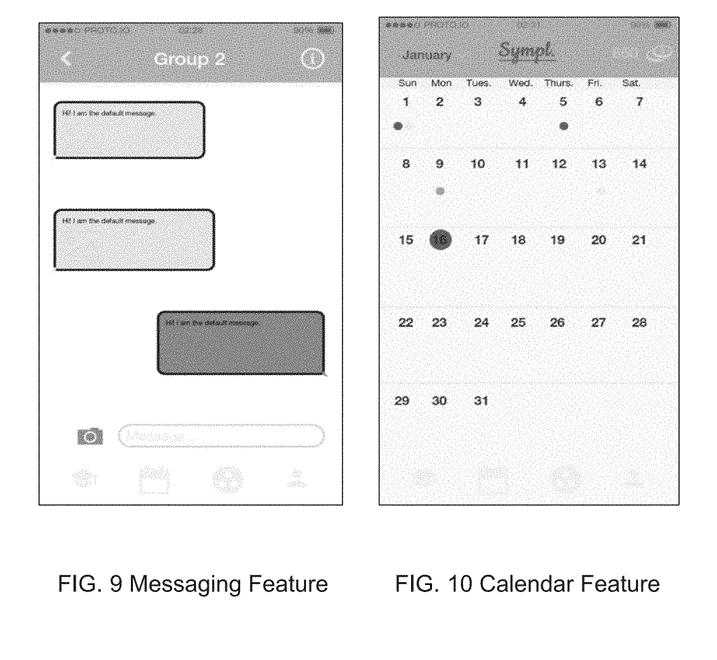

It is contemplated that while a part of a study group or a study session, users will gain access to several additional features including messaging, file sharing, and a rating feature. Messaging allows collaboration between classmates including being able to coordinate a study session that will work with everyone, being able to find the study group while looking, and/or communicate between two different study groups. An example of the messaging feature is shown in FIG. 9. Here, within the app, the students in the group are able to carry on specific conversations about the subject matter and the class. In yet another example, a file sharing capability is provided where users and professors will be able to share notes, study guides, and additional class.

In still yet another example, a rating feature can be provided that will allow students to rate fellow classmates on their participation with the group. The rating can be stored and represent the logged information as a personalized score such as a GPA. For example, users can rate their classmates' study performance on a 4.0 scale. The ratings can be made visible only to the user who received the rating, and to the learning system hosted on the remote network. The user's rating can be used as a method for self-reflection so as to improve the performance of the user in later study sessions with the end goal of improving their grade. The student's rating can be shown on the profile found in FIG. 4.

The present disclosure further provides for a learning feature built into the system and application. The learning system operates by taking all of the data logged from the application and running a principal component analysis on it with regards to the actual GPA a student submits that they received at the end of the semester. The system can then conclude that certain features have a greater or lesser impact on a student's GPA than others. These features can include average length of study session, number of study groups the user is associated with, their study session GPA, or previous classes' performance. By applying the weights of the features from the associated eigenvalues after normalization and putting them into a classifier, suggestions based off of these predictions of how the student could perform better in the class can be given. For example, a notification could indicate that if an individual user were to study an additional 12 hours over the next week, they would have a good chance at receiving a certain score on their exam. As each of the classifiers work differently in how it determines its prediction, an ensemble of learning techniques can be used to make these predictions as results can be averaged so as to obtain the highest accuracy predictions. Examples of these techniques include K-Nearest Neighbor, Linear Regression, Logistic Regression, Decision Trees, and/or Neural Networks.

In one example, all students as well as the instructors and teaching assistant associated with a class will be notified and automatically added as a part of a class study group. This study group has most of the features mentioned above including file sharing, messaging, and access to each users profile page. An example of a user's profile page can be found on FIG. 4. The user profile page allows students to provide information to develop a basic connection and a level of trust with their classmates. Accordingly, a user can provide on his or her profile, one or more user specific items such as a picture, a name, and a major, among others. From the user who creates the profile pages perspective, the application also can detail the GPA rating they have been assigned, the in-app currency they have acquired, access to the university class list, the ability to change their password, the groups they are associated with, the ability to create a new group, a toggle to indicate they are studying, and the ability to ask questions or make suggestions to the creators.

In another example, under circumstances when an institution does not make class information such as exam dates or homework deadlines available, the system and method allows for collecting information through a crowd sourcing approach. Crowd sourcing allows developers to ask their users to supply them information. In this example, at the beginning of the semester, students and instructors can be asked to input information located on the syllabus. In case a syllabus item changes, it is up to the users and instructor to update the information on the application. However, approved updates can be visible to every user within a class-wide group. In yet a further example, an in-app currency can be formed to incentivize this behavior. The users can use the currency later on items such as raffles or prizes. FIG. 4 shows currency on the user profile. In an example, these prizes can be anything determined to be of value to a particular institution and range from coupons from local stores to signed football helmets. Additionally, in the case there is a lack of input after a period of time, monetary incentives can be used to encourage submission of correct information. It is contemplated to include a step to verify items added to a calendar by having other user's up-vote items on the syllabus, which we can also be incentivized with in-app currency.

Once the syllabus information is obtained, a calendar feature (FIG. 10) can be generated. A user can access the calendar feature from the student's class list page. There, the user can see all of the syllabus information on a semester, monthly, weekly, or daily basis. Users are also able to create their own information into their personalized calendar, including goals and milestones. Each of these can be made to have an automatic reminder feature so as to ping the user (through phone or otherwise) within a time frame of each assignment, for example. A user may be able to adjust the times, the amount of times, and to turn off this feature. This allows the student to consistently stay up to date and never miss another assignment. An example calendar feature is shown in FIG. 10 having exemplary dots shown for due dates on the first, fifth, and ninth day of the month.

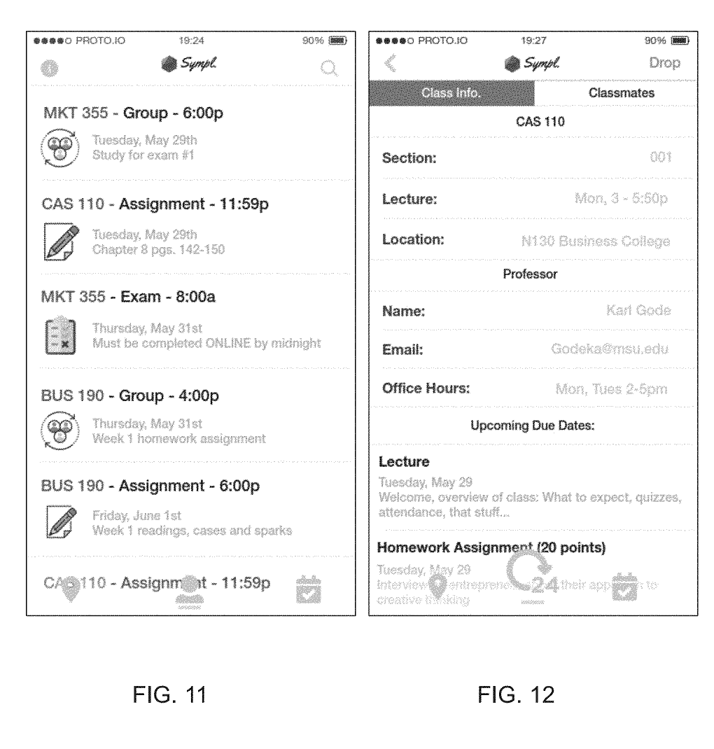

Referring to FIGS. 11 and 12, an example news feed feature is shown associated with a user's specific schedule and list of enrolled classes. Here, as shown in FIG. 11, the app compiles all deadlines, notifications, study groups, tests, etc. associated with that user's particular schedule and lists it chronologically. This provides assistance with schedule management and is automated. Moreover, each class notification in the list can be expanded to provide additional information as shown in FIG. 12. This can be done on a weekly basis and allow the user to scroll among the various deadlines.

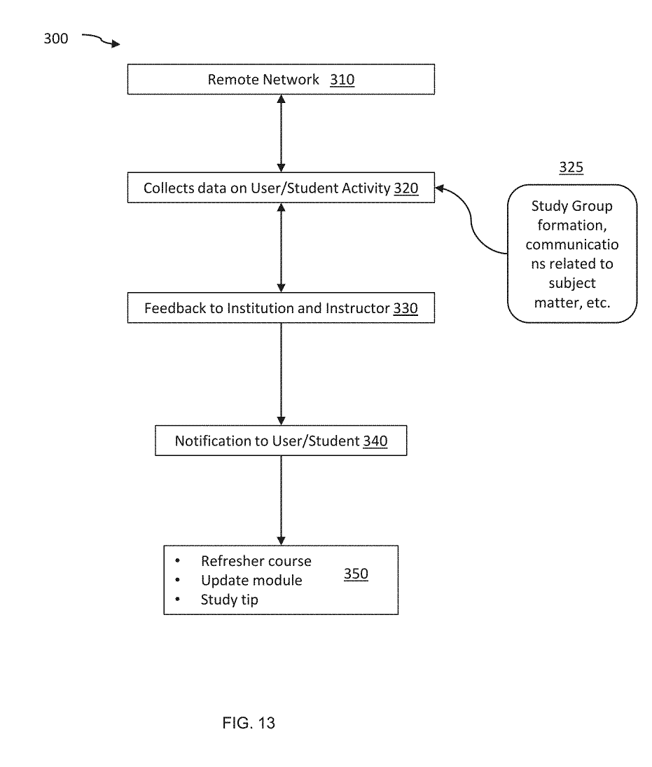

Referring to FIG. 13, a process flow diagram for data collection and feedback is shown. In this example, data collection process 300 provides for a remote network 310 that is accessible remotely by a mobile application on a mobile device or a computing device. That data associated with users/students is collected at box 320 and processed. The collected data, shown at box 325, includes any activity associated with the students such as frequency and type of study groups being formed, communication among the students, and subject matter being discussed. Based on that data, feedback can be provided to the institution and/or the instructor for a particular class as shown at box 330. If appropriate, certain notifications can be generated and fed back to the user as shown at box 340. This can include box 350 items such as a refresher course, an updated module to review, and/or a study tip, among others. For example, if a user is attending several study sessions associated with a particular topic, the feedback data can determine that the user needs a notification to review a previous chapter or section to help their understanding. Moreover, the instructor may be notified that the students are struggling with a particular subject and that several study groups have been formed as a result.

The foregoing description of various forms of the present disclosure has been presented for purposes of illustration and description. It is not intended to be exhaustive or to limit the present disclosure to the precise forms disclosed. Numerous modifications or variations are possible in light of the above teachings. The forms discussed were chosen and described to provide the best illustration of the principles of the present disclosure and its practical application to thereby enable one of ordinary skill in the art to utilize the present disclosure in various forms and with various modifications as are suited to the particular use contemplated. All such modifications and variations are within the scope of the present disclosure as determined by the appended claims when interpreted in accordance with the breadth to which they are fairly, legally, and equitably entitled.

What is claimed is:

1. A system for peer-to-peer collaboration and learning through a mobile application, the system comprising:
(a) a remote network hosting a database of institution specific information including a list of available classes associated with the institution;
(b) a mobile application provided on a mobile device operable to connect remotely to the remote network;
(c) a profile feature provided in the mobile application, the profile feature being customizable to a user of the application allowing the user to input information including information associated with the institution;
(d) a menu feature allowing access to the list of available classes associated with the institution, the menu feature provided in the mobile application allowing the user to select a class from the institution the user is enrolled;
(e) a classmate feature provided in the mobile application operable to provide a list of classmates enrolled in a corresponding class, the classmate feature operable to allow communication between the user and at least one classmate through the application;
(f) a study group feature provided in the mobile application to allow the user to generate a study group having one or more parameters selected from the group consisting of a privacy setting, number limit, location, time, subject, content, and combinations thereof; and
(g) a map feature provided in the mobile application, the map feature operable to submit a notification to the user of at least one study group available to the user, wherein the notification includes at least one parameter of the study group, wherein the study group feature allows the user to submit a request to join and further allows a member from the study group to submit a response to allow or deny the request.

2. The system of claim 1, wherein the parameter provided in the map feature is a location parameter associated with a map of the institution.

3. The system of claim 1, further comprising a grading feature that allows for classmates to submit a grade of other classmates associated with study habits, wherein the grade for the user is shown on the profile feature.

4. The system of claim 1, further comprising a calendar feature provided in the application, the calendar feature operable to provide class specific information associated with the enrolled class, wherein the class specific information is located in the database of institution specific information hosted on the remote network, and wherein the class specific information includes at least one member selected from the group consisting of syllabi content, deadlines, content provided from an instructor, and combinations thereof.

5. The system of claim 1, wherein the mobile application includes a messaging feature operable to allow for communication between the user and at least one other user through direct messaging.

6. The system of claim 1, wherein the user is a student of the institution.

7. The system of claim 1, wherein the institution is an institution of higher education.

8. The system of claim 1, further comprising a news feed feature in the application that compiles at least some data and information related to the user and displays that compiled information in chronological order for a given time period.

9. The system of claim 1, wherein user behavior and study group formation is tracked and collected as data.

10. The system of claim 9, wherein the collected data is processed and provides feedback to the institution.

11. The system of claim 9, wherein the collected data is processed and triggers notifications to be sent to the user corresponding to recommendations based on the processed data.

12. A method for peer to peer collaboration using a mobile application, the method comprising:
(a) hosting a database of institution specific information including a list of available classes associated with an institution on a remote network;
(b) providing a mobile application on a mobile device operable to connect remotely to the remote network;
(c) generating a user specific profile through a profile feature provided in the mobile application, wherein the profile feature is customizable to a user of the application allowing the user to input bibliographical information including information associated with the institution;
(d) selecting at least one class associated with a class the user is enrolled from a menu feature provided in the mobile application, the class being selected from a list of classes provided from the database of institution specific information hosted on the remote network;
(e) connecting with at least one classmate through a classmate feature provided in the mobile application, the classmate feature providing a list of classmates also enrolled in a selected class to the user, the classmate feature operable to allow communication between the user and at least one classmate;
(f) generating a study group having at least two classmates from an enrolled class through a study group feature provided in the mobile application, the study group feature having one or more parameters selected from the group consisting of a privacy setting, number limit, location, time, subject, content, and combinations thereof;
(g) notifying, through a notification feature of the mobile application, at least one user not part of the generated study group of the formation of the study group and its availability to the user through a map feature provided in the application, wherein the notification includes at least one parameter of the study group; and
(h) submitting a request to join the study group through the study group feature and allowing a member from the study group to submit a response to allow or deny the request.

13. The method of claim 12, wherein the parameter provided in the map feature is a location parameter associated with a map of the institution.

14. The method of claim 12, further comprising a grading feature that allows for classmates to submit a grade of other classmates associated with study habits, wherein the grade for the user is shown on the profile feature.

15. The method of claim 12, further comprising a calendar feature provided in the application, the calendar feature operable to provide class specific information associated with the enrolled class, wherein the class specific information is located in the database of institution specific information hosted on the remote network, and wherein the class specific information includes at least one member selected from the group consisting of syllabi content, deadlines, content provided from an instructor, and combinations thereof.

16. The method of claim 12, wherein the mobile application includes a messaging feature operable to allow for communication between the user and at least one other user through direct messaging.

17. The method of claim 12, further comprising a news feed feature in the application that compiles at least some data and information related to the user and displays that compiled information in chronological order for a given time period.

18. The method of claim 12, wherein user behavior and study group formation is tracked and collected as data and processed to provide feedback to the institution.

19. The method of claim 18, wherein the collected data is processed and triggers notifications to be sent to the user corresponding to recommendations based on the processed data.
